(19) United States
(12) Patent Application Publication
(10) Pub. No.: US 2003/0090244 A1
(43) Pub. Date: May 15, 2003

(54) Multislice DC-DC converter

(76) Inventors: Krishna Shenai, Naperville, IL (US); Siamak Abedinpour, Chandler, AZ (US)

Correspondence Address: Julian F. Santos, McDonnell Boehnen Hulbert & Berghoff, 32nd Floor, 300 S. Wacker Drive, Chicago, IL, 60606, US

(21) Appl. No.: 10/288,069

(22) Filed: Nov. 5, 2002

Related U.S. Application Data
(60) Provisional application No. 60/338,510, filed on Nov. 5, 2001.

(51) Int. Cl. G05F 1/24

(52) U.S. Cl. 323/259

(57) ABSTRACT

A novel monolithic step-down dc-dc buck converter that uses two or more (“n”) parallel slices to achieve a high output current with a small filter capacitor is provided. Each of the n slices may be operated with a phase difference of 360°/n. Each of the converter slices may be based on a synchronous rectifier topology to avoid the excessive power losses introduced by the diode component of conventional step-down buck converters. Hysteretic control may be used (with or without pulse-width modulation and pulse-frequency modulation) to provide an internal gate-drive waveform without the need to provide a dedicated clock signal or oscillator circuit.

The hysteretic control is further refined using digital control techniques to enforce a brief dead time between the activation of each slice such that undesirable circulating currents are prevented. A significant advantage of the proposed multi-slice step-down dc-dc buck converter and its associated control is that the semiconductor switches, filter inductors and capacitor, and the control circuit may be fabricated as part of a single monolithic integrated circuit.

### PRIORITY AND RELATED APPLICATIONS

The present patent application claims priority under 35 U.S.C. §119(e) to U.S. Provisional Patent Application Serial No. 60/338,510 entitled “Monolithic Multi-Slice Synchronous Buck Converter,” filed on Nov. 5, 2001, the full disclosure of which is incorporated herein by reference.

The following references to non-provisional patent applications are incorporated by reference herein:

“DC-DC Converter with Resonant Gate Drive” to Shenai et al., Attorney Docket No. 02,795-A, filed concurrently herewith;

“DC-DC Converter with Current Control” to Shenai et al., Attorney Docket No. 02,798-A, filed concurrently herewith;

“Monolithic Battery Charger” to Shenai et al., Attorney Docket No. 02,796-A, filed concurrently herewith; and

“Synchronous Switched Boost and Buck Converter” to Shenai et al., Attorney Docket No. 02,1184, filed concurrently herewith.

### BACKGROUND

1. Field

The field of the invention is related to dc-dc converters and more particularly to voltage step-down dc-dc converters.

2. Related Art

The diversity of Very Large Scale Integration (VLSI) integrated circuits often requires that a circuit utilize a supply voltage that is not available within its target platform. Accordingly, a voltage converter is typically used to translate a non-target platform voltage into one suitable for the VLSI integrated circuit. Often the converter comprises one or more voltage step-down or buck-type converters. Since many of these platforms require high efficiency, compact dimensions, rapid response to load conditions, and high power output, several modifications of conventional switching DC-DC converters are desirable. One solution to is to create a number (“n”) multiple parallel step-down buck converters (hereinafter referred to as a multislice converter) so that the aggregate output current is n times higher than with a single converter. Efficiency over 80% can be achieved with such devices, but the construction of present converters often requires a hybrid solution that combines VLSI control integrated circuits, external passive (e.g., filtering) components, and external power semiconductor switches. In addition, these converters suffer from low switching frequencies that cause large granularity in the responsiveness of the step-down buck converters to load conditions.

### SUMMARY

One improvement of the technology described herein is the use of very high-speed control circuitry. Unlike conventional controls that require a clock signal or oscillator circuit to generate a reference frequency, the control of one preferred embodiment of the converter is oscillator-less and internally and dynamically generates its own switching pulses. The result is highly adaptive to a wide range of applications and equally dynamic switching patterns. The oscillator-less-control circuit has no fixed frequency, and can very rapidly and accurately enabling adjustment of both the frequency and the duty cycle of the pulse. Conventional control (pulse-width and/or pulse-frequency modulation) may also be used, when for example, the control circuit may be tuned to a single reference frequency. The control circuit may be further refined using digital techniques to ensure that a dead time is inserted between the activation of each successive converter slice, and between the deactivation of one switch and the activation of another within a given slice. These dead times prevent undesirable circulating currents.

Using the high-speed control described herein, all the components of the buck converters (semiconductor switches, filter inductors and capacitor, and the control circuit) may be fabricated as part of a single monolithic integrated circuit.

A novel monolithic step-down dc-dc buck converter that uses two or more parallel slices to achieve a high output current with a smaller filter capacitor is provided. The n slices may be operated with a phase difference of 360°/n. Each of the converter slices may be based on a synchronous rectifier topology to avoid the excessive power losses introduced by the diode component of conventional step-down buck converters. Hysteretic control may used (with or without pulse-width modulation and pulse-frequency modulation) to provide an internal gate-drive waveform without the need to provide a dedicated clock signal or oscillator circuit. The hysteretic control may be further refined using digital control techniques to enforce a brief dead time between the activation of each slice such that undesirable circulating currents are prevented. High frequency (above 1 MHz) controllers using pulse-width or pulse frequency modulation may also be used.

One advantage of the proposed multi-slice step-down dc-dc buck converter and its associated control circuitry is that the semiconductor switches, filter inductors and capacitor, and the control circuit may be fabricated as part of a single monolithic integrated circuit, a single chip integrated circuit, or some combination thereof.

### BRIEF DESCRIPTION OF THE DRAWINGS

Exemplary embodiments of the invention are described below in conjunction with the appended Figures, wherein like reference numerals refer to like elements in the various Figures, and wherein:

FIG. 1 is a first schematic view of a dc-dc voltage converter in accordance with a preferred embodiment of the converter;

FIG. 2 is a second schematic view of a dc-dc voltage converter in accordance with a second preferred embodiment of the converter;

FIG. 3 is a third schematic view of a dc-dc voltage converter in accordance with a second preferred embodiment of the converter;

FIG. 4 is a schematic view of a multistage controller for a dc-dc voltage converter in accordance with a second preferred embodiment of the converter; and

FIG. 5 is a fourth schematic view of a dc-dc voltage converter in accordance with a third preferred embodiment of the converter.

### DETAILED DESCRIPTION OF THE PRESENTLY PREFERRED EMBODIMENTS

In the following detailed description, numerous specific details are set forth in order to provide a thorough understanding of the invention. However, it will be understood that the present invention may be practiced without these specific details. In other instances, well-known methods, procedures, components and circuits have not been described in detail, so as not to obscure the present invention. Further, the presently preferred embodiments disclosed are for exemplary purposes only and other embodiments, such as those disclosed in the concurrently filed non-provisional applications entitled (i) “DC-DC Converter with Resonant Gate Drive,” (ii) “DC-DC Converter with Current Control,” (iii) “Monolithic Battery Charger,” and (iv) “DC-DC Converter with Single Gate Drive,” may be employed in lieu of or in combination with of the embodiments disclosed.

1. Exemplary Architecture

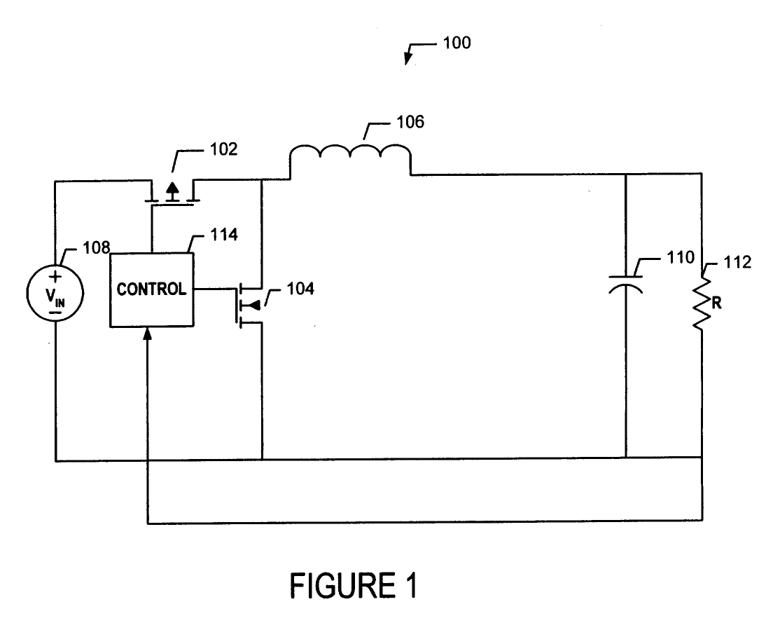

FIG. 1 is a schematic diagram of a single dc-dc step-down voltage converter 100 used as a single stage or slice of a preferred embodiment of a multislice converter. The step-down voltage converter 100 and/or the multislice converter may be fabricated as (i) an integral part of a multifunctional integrated circuit (i.e., with other functional circuitry), (ii) one or more independent monolithically formed integrated circuits, (iii) a single independent monolithically formed integrated circuit, and/or (iv) any other monolithic or hybrid formation.

It is contemplated that the step-down converter 100 and other components of the multislice converter may be fabricated using known fabrication methods, techniques and materials including Silicon/Gallium Arsenide (Si/GaAs), Silicon/Germanium (SiGe), and/or Silicon/Carbide (SiC). Included amongst these techniques are Complementary Metal Oxide Semiconductor (CMOS) fabrication processes, Bipolar Complementary Metal Oxide Semiconductor (BiCMOS) fabrication processes, Heterojunction Bipolar Transistor (HBT) fabrication processes, and/or Metal Semiconductor Field Effect Transistor (MESFET) fabrication processes. The step-down converter 100 and the other components of the multislice converter are preferably fabricated using CMOS technology using the well-known fabrication design and construction technique referred to as MOSIS, which allows for 0.5-μm minimum features.

The step-down converter 100 accomplishes a voltage step-down through the interaction of a supply voltage source 108, a N-channel Metal Oxide Semiconductor (NMOS) synchronous rectifier 104, and a P-channel Metal Oxide Semiconductor PMOS switch 102. The “chopped” output voltage provided by switches 102 and 104 is provided to the low-pass LC filter, which comprises an inductor 106 and an capacitor 110.

In an alternative embodiment, the architecture of switch 102 may include (i) one or more enhancement or depletion mode P-channel metal oxide semiconductor (PMOS) transistors, (ii) one or more enhancement or depletion mode N-channel metal oxide semiconductor (NMOS) transistors, (iii) one or more PMOS switches, (iv) one or more NMOS switches, and/or (v) any other monolithic switch capable of switching at frequencies of at least one MHz. The architecture of rectifier 104 may include (i) one or more diodes; (ii) one or more synchronous rectifiers, which may be constructed from one or more enhancement or depletion mode NMOS or PMOS transistors; and/or (iii) any other monolithic rectifier having the ability to switch from a conducting state to a non-conducting state at a frequency in excess of approximately one MHz.

In one exemplary embodiment, when the architecture of switch 102 and the rectifier 104 are configured as transistors or semiconductor switches, the switch 102 and the rectifier 104 may be both constructed from the same type topology, e.g., the same NMOS or PMOS material. The switch architecture and the rectifier architecture, however, are preferably constructed as transistors or semiconductor switches having opposite type conduction channel materials. For example, when the switch 102 is constructed from PMOS, the rectifier 104 is preferably constructed from NMOS, and vice versa. One advantage of this topology is simplification of controller circuitry.

This simplification is realized by the reduction in number of signals, and corresponding circuit traces, to switch 102 and the rectifier 104. Because the switch 102 and the rectifier 104 need to operate out of phase, one signal (from, e.g., a single gate driver) can control both, as opposed to when the switch 102 and the rectifier 104 are constructed with the same topology. In this opposite conduction channel configuration, delay mechanisms might not be necessary to prevent both the switch 102 and the rectifier 104 from turning on at the same time (which could happen if two of the same type conduction channel devices are used.).

In the opposite conduction channel configuration, when the rectifier 104 comprises a NMOS type rectifier, the physical gate length of the PMOS type switch to 102 is generally three to four times the gate length of the NMOS rectifier for the PMOS type switch to achieve same current carrying capacity and similar switch speeds as the NMOS rectifier. Given that the physical size of the PMOS type switch is larger than the NMOS type rectifier, which ultimately effects circuit and die size, NMOS type switches and rectifiers are preferred over PMOS type switches and rectifiers.

Notably, a slice (or a plurality of slices) can be integrated monolithically by choosing a sufficiently high switching frequency to ensure low value of passive components. For example, a typical switching frequency of 100 MHz allows for inductor values of less than 100 nH and capacitance values of approximately 1 nF. Advantageously, such values can be provided and/or integrated on-chip (i.e., integrated into or integral to an integrated circuit). Using such practical components, the overall efficiency may be improved by up to 10% with the use of this topology over conventional multislice synchronous converters, even if on-chip inductors having poor quality factor (e.g., a Q factor restricted to less than 15) are used.

In one exemplary embodiment, the inductor 106 may be fabricated as a thin-film inductor having a value of approximately 100 millihenry and below. These thin film inductors may be formed atop, but are preferably integrated into, the same package or wafer die as the converter. While the inductor 106 may be formed directly atop the converter, one or more insulating or facilitative thin-film layers may separate the inductor 106 from the converter. These facilitative layers may include one or more sacrificial layers, (i.e., material used during processing to construct the final product, but not present in the final product), and/or one or more beneficial layers (i.e., material used during processing to construct the final product, and present in the final product).

Alternatively, the inductor 106 may be formed as a monolithic or discrete, off-chip, coil or spiral wire-wound inductor in (i) a hermetically-sealed (e.g., ceramic encased) leaded package, (ii) a hermetically-sealed surface mount package, and/or (iii) flip chip form. Such inductors may be similar to the types of inductors commonly used in radio frequency (RF) type circuits operating in the range from about two Mhz to about five Mhz. These inductors are available from such suppliers as Murata Electronics North America, Inc., having offices at Corporate Headquarters 2200 Lake Park Drive, Smyrna, Ga. 30080-7604 U.S.A.; Bourns Inc., having offices at 1200 Columbia Avenue, Riverside, Calif. 9250, U.S.A.; CoilCraft having offices at 1102 Silver Lake Road, Cary Ill. 60013, U.S.A.; U.S. Microwaves A Division Of Semiconix Corporation having offices at 2964-2966 Scott Blvd Santa Clara, Calif. 95054, U.S.A.; Toko America, Inc. having offices at 1250 Feehanville Drive Mt. Prospect, Ill. 60056, U.S.A.; Kyocera America, Inc. having offices at 8611 Balboa Ave. San Diego, Calif. 92123-1580, U.S.A. Each of these suppliers can provide high accuracy, high Q inductors for high frequency as well as power applications. Other inductor materials and types, and other manufacturers may be used as well.

In addition to the other converter components, the architecture of the capacitor 110 may include a monolithically formed coupling capacitor having a storage capacity of approximately a few nanofarads and below. Similar to the inductor 106, the capacitor may be fabricated as a thin-film capacitor; similar to the types commonly used in radio frequency (RF) type circuits operating in the range from about two Mhz to about five Mhz. These thin film capacitors may be formed atop, but are preferably integrated into, the same package or wafer die as the converter. While the capacitor 110 may be formed directly atop the converter, one or more insulating or facilitative thin-film layers may separate the capacitor 110 from the converter.

Alternatively, the capacitor 110 may be formed as a monolithic or discrete, off-chip, capacitor in (i) a hermetically-sealed (e.g., ceramic or tantalum encased) leaded package, (ii) a hermetically-sealed surface mount package, and/or (iii) flip chip form. These capacitors are available from any of the suppliers listed above. And each of these suppliers can provide capacitors for high frequency applications that exhibit high accuracy, and power low dissipation. Other capacitor materials and types, and other manufacturers may be used as well.

2. Exemplary Operation

The operation of the single slice preferred embodiment of the multislice converter may occur as follows. The converter 100 uses a PMOS switch 102 in the main current path, and an NMOS switch 104 that acts as a synchronous rectifier to divert the current in inductor 106 when the PMOS 102 is turned off. The current through NMOS 104 is referred to as the freewheeling current. When the NMOS switch 104 is closed, the voltage of the internal node (or common connection point) is at or near ground potential. When the PMOS switch 102 is closed, the voltage of the internal node is at the supply voltage potential. The NMOS and PMOS switches are closed alternately. By adjusting the duty cycle of the switches 102 and 104, the average voltage at the internal node can be controlled (e.g., providing a square wave) between 0 and the supply voltage. This square wave signal is then filtered to a DC level by the low-pass filter. Output current through a load (represented by the load resistor R 112) is then drawn from across the output filter capacitor 110.

The control circuit 114 operates in a manner such that the output voltage is continuously compared to a desired potential, or a reference potential. The output voltage may be reduced by way of a voltage divider prior to comparison. One such controller is a hysteretic controller, as described in U.S. Pat. No. 5,959,439, entitled “Monolithic DC to DC Converter”, issued Oct. 19, 1999, the entirety of which is incorporated by reference herein. The hysteretic controller operates without an oscillator, using direct feedback to control switches 102 and 104. If the output voltage is higher than the nominal (or reference) voltage, then the NMOS switch 104 is activated (and PMOS 102 is deactivated). If the output voltage is lower than the nominal (reference) voltage, then the PMOS switch 102 is activated (and conversely, the NMOS 104 is deactivated).

The switches 102 and 104 may be controlled using a single gate driver, instead of separate gate drive signals on separate outputs as shown in FIG. 1. The use of a single drive signal on a single conductive lead is possible due to the use of complementary PMOS and NMOS devices 102 and 104, as described in U.S. patent application entitled “Synchronous Switched Boost and Buck Converter” noted above. Specifically, the devices are intended to operate in a complimentary fashion such that only one device is conducting at a time. In this regard, a high gate drive voltage (typically a few volts, or a voltage otherwise sufficient to saturate the device) will cause NMOS switch 104 to conduct, while simultaneously causing PMOS switch 102 to turn off. Likewise, a negative voltage will cause PMOS switch 102 to conduct, while simultaneously causing NMOS switch 104 to turn off. The switches may be operated without the need for an offset or delay, which is commonly used to avoid shoot-through current that results when both devices are simultaneously conducting, primarily due to the high frequency of switching used by the control circuit, which is preferably greater than one Megahertz.

In the event shoot through current is a concern in a given converter design, a buffer driver/timer circuit may be used to stagger the gate drive signals. The buffer driver/timer simultaneously or otherwise synchronously drives the switches 102 and the rectifier 104 between their respective and polar opposite ON states and the OFF states. The buffer driver may include one or more delay mechanisms to insure that when the PMOS switch 102 is in its ON state, NMOS switch 104 is in its OFF state, and vice-versa. An exemplary buffer driver/timer includes a buffer-driver input, a first-buffer-driver output coupled to the PMOS switch 102, and a second-buffer-driver output coupled to the NMOS switch 104.

Coupled between the buffer-driver input and the first-buffer-driver output is a first-logic-switch-driver-circuit that includes a NOR gate. The NOR gate has an output, a first input directly coupled to the buffer-driver input and a second input coupled to the bufferdriver input via four inverters, namely a first inverter, a second inverter, a third inverter, and a fourth inverter. The output of the NOR is coupled to a fifth inverter, which in turn is coupled to the first-buffer-driver output.

Similarly, coupled between the buffer-driver input and the second-buffer-driver output is a second-logic-switch-driver circuit. The second-logic-switch-driver circuit has an input directly coupled to the buffer-driver input and an output directly coupled to the second-buffer-driver output. Coupled to the input is a sixth inverter that in turn is coupled to a seventh inverter. The seventh inverter in turn is coupled to output of the second-logic-switch-driver circuit.

The buffer driver may operate as follows. When fed into the buffer-driver input, the single-gate-driver signal (e.g., a feedback controlled pulse-width-modulated signal or hysteretic control signal) is fed to both the first and second-logic-switch-driver-circuit. Because of the propagation delay of each of the inverters and the NOR gate, the single-gate-driver signal that is fed to the buffer-driver input insures that when the PMOS switch 102 is in its ON state, the state of the NMOS switch 104 is in its OFF state, and vice-versa.

Starting with a transition from a low state to a high state of the single-gate-driver signal that is fed directly to its first input, the NOR gate produces (or otherwise transitions from a high state signal to) a low state signal, regardless of the state of its other input. This low state signal is fed to the fifth inverter, which inverts it to a high state signal. The high state signal is then fed to the PMOS switch 102, which when comprised of an enhancement-mode-p-channel MOSFET, causes the PMOS switch 102 to switch to its OFF state.

Because the NOR gate and the fifth inverter are in series, the high state signal that is fed to the PMOS switch 102 lags behind the high state of the single-gate-driver signal by the combined propagation delay of the NOR gate and the fifth inverter. While the propagation delay of the NOR gate and the fifth inverter may be of the same duration, preferably and in practice, the propagation delay of NOR gate is less than the propagation delay of the fifth inverter.

When the transition from the low state to the high state of the single-gate-driver signal is fed directly to the second-logic-switch-driver-circuit, the sixth inverter inverts the high state of single-gate-drive signal to produce a low state signal. This low state signal is fed to the seventh inverter, which inverts its incoming signal to produce a high state signal. The high state signal is then fed to the rectifier 130, which when comprised of a enhancement-mode-n-channel MOSFET, causes the rectifier 130 to enter its active region and switch to its ON state.

Since the sixth and seventh inverter are in series, the high state signal that is fed to the NMOS switch 104 lags behind the high state of the single-gate-driver signal by the combined propagation delay of the sixth and seventh inverters. The propagation delay of the sixth and seventh inverters may be of the same duration or different duration.

In addition, the individual propagation delay of the sixth and seventh inverters may have the same duration as the NOR gate and the fifth inverter. Assuming no propagation delay difference for the pinch-off of a MOSFET constructed PMOS switch 102 and NMOS switch 104, preferably and in practice, the combined propagation delay of the sixth and seventh inverters is longer than the combined propagation delay of the NOR gate and the fifth inverter. This insures that when the NMOS switch 104 switches to its ON state, the PMOS switch 102 is already in its OFF state. More or fewer components can be used and the operation of the buffer driver/timer may vary from the exemplary embodiment disclosed. More detail regarding the buffer driver/timer is described in U.S. patent application entitled “Monolithic Battery Charger”, attorney docket number 02-796-A, filed concurrently herewith, the entirety of which is incorporated herein by reference.

The switches 102 and 104 may also be controlled using a resonant gate drive circuit as described in U.S. patent application entitled “DC-DC Converter With Resonant Gate Drive”, attorney docket number 02-795-A, filed concurrently herewith, the entirety of which is incorporated herein by reference. As disclosed therein, both the PMOS switch 102 and NMOS switch 104 may be driven by the same gate drive circuit using a single inductor and capacitor configured as a resonant gate drive. Alternatively, the drive signals may be provided by two separate resonant gate drive circuits having separate inductors. In the embodiment having two separate inductors, the inputs to the gate drivers, and hence the gate drive outputs, may be delayed with respect to each other to ensure that whichever device is presently conducting is turned off prior to turning on the other switching device.

By adding parallel slices of identical converters, the total output current is increased. Preferably one inductor is used per slice and a single filter capacitor is shared by all slices. Alternatively, a plurality of capacitors may be used. One such alternative may provide a separate output capacitor for each slice.

Operation of multiple slices is preferably interleaved in time such that only one converter slice is active at a time. That is, for n slices, each slice is operated 360°/n out of phase. Preferably, the duty cycle of the PMOS device in any given slice is no greater than (100/n) %. In this manner, only one slice at any give time will be drawing current from the input supply 108. For example, in three slice multislice converter the timing signals are phased apart by 120 degrees. If the maximum duty cycle is no greater than 33.3%, then it is assured that only one device will draw current from the input supply 108 at any given time. In the event that more than one slice can conduct at one time, then the duty cycle may be greater than (100/n) %.

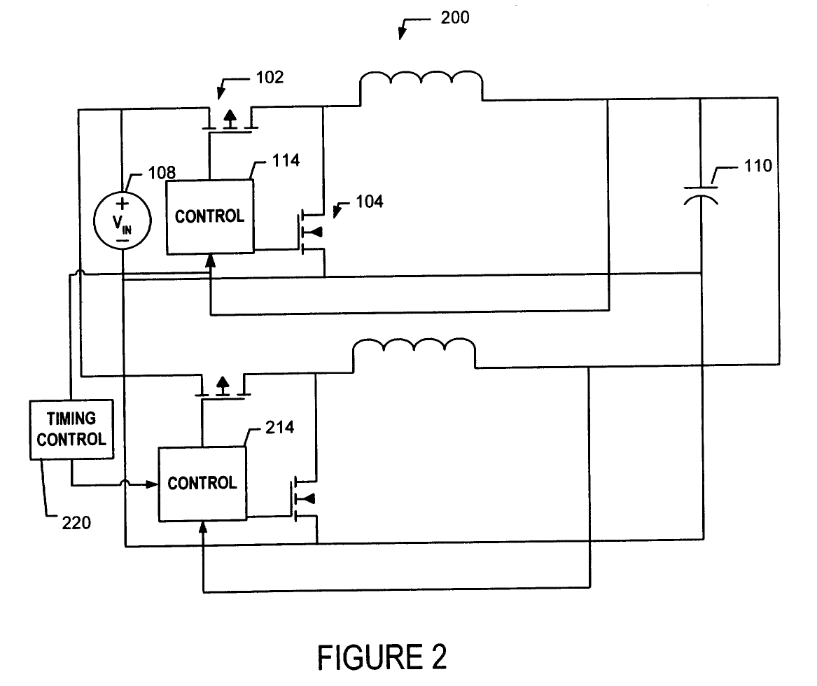

Referring now to FIG. 2, a schematic diagram of a dc-dc step-down voltage converter used as a preferred embodiment of a multislice converter 200 is provided. The multislice converter 200 includes two converter slices, each of which has its own feedback controller circuit 114, 214. In addition, the multislice converter 200 includes a timing/control source 220 that provides each controller circuit 114, 214 with phased-delayed-timing signal. The phased-delayed-timing signal may be actual ramp signals that are appropriately phased for use by the individual pulse width modulation (PWM) controllers.

Alternatively, the phased-delayed-timing signal may be a clock signal for use by the individual controller circuits 114, 214 to produce the appropriately phased timing signals. That is, each controller 114, 214 may include a ramp generator for use in generating the appropriate gate drive signal or signals, as described above.

3. Exemplary Multislice Embodiments

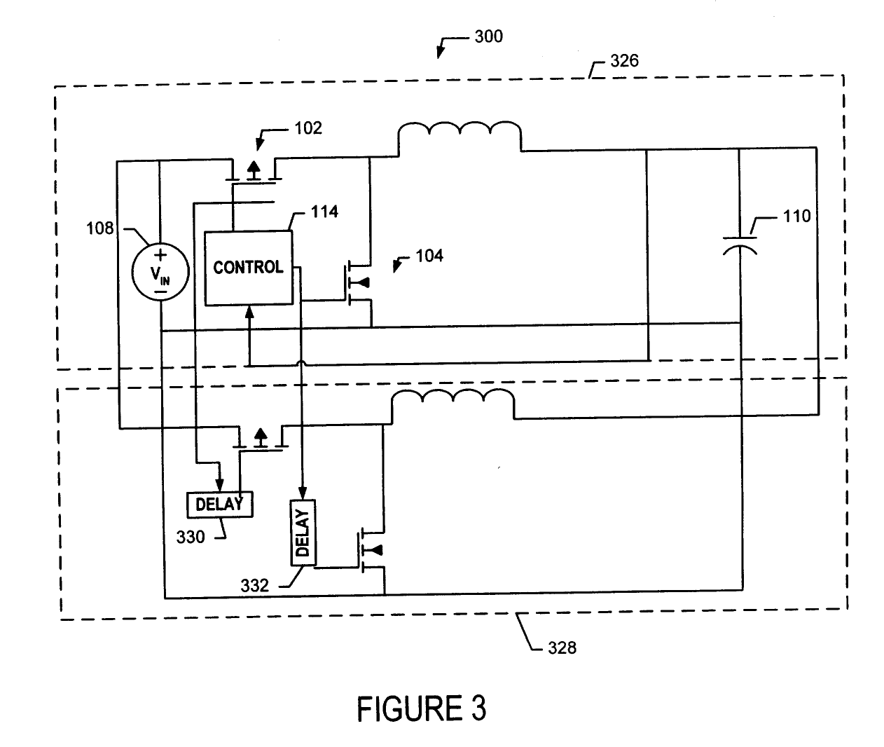

Referring now to FIG. 3, a schematic diagram of a dc-dc step-down voltage converter used as a preferred embodiment of a multislice converter 300 is provided. The multislice converter 300 illustrated in FIG. 3 is similar to the multislice converter 200 illustrated in FIG. 2 in most respects, except as described herein or otherwise noted. The multislice converter 300 includes two parallel converter slices 326, 328, and a feedback controller circuit 114 that provides PWM control, Pulse Frequency Modulation (PFM) control, and/or hysteretic control. Of course, this configuration may be viewed as a plurality of slices without an integral feedback controller circuit 114, in combination with a separate controller that provides switching signals to each slice.

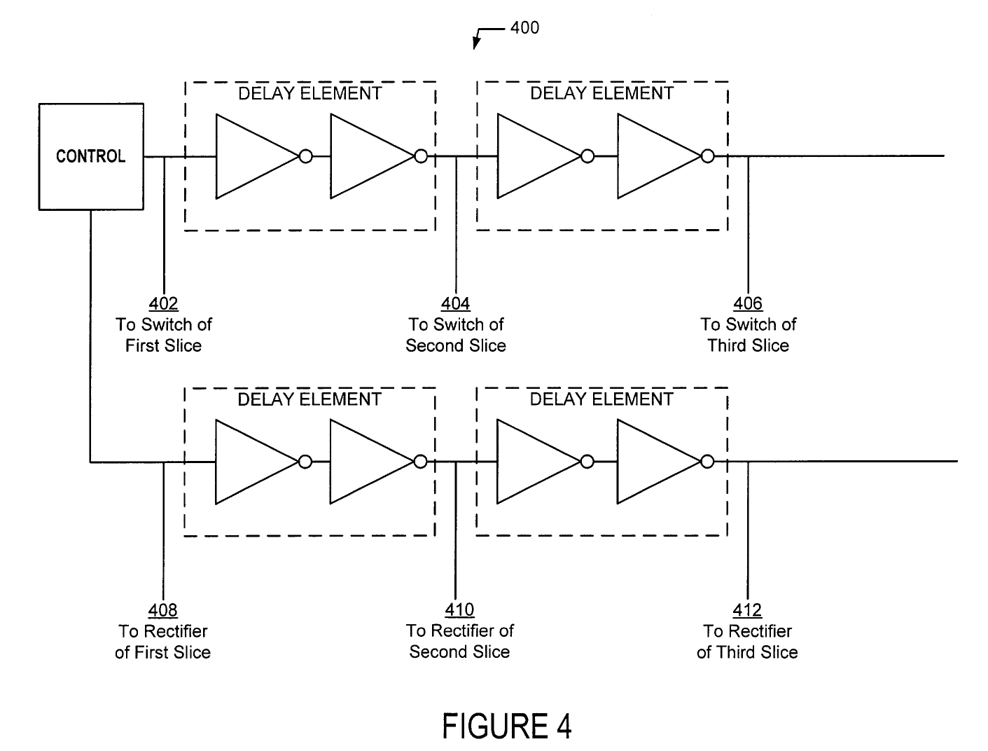

In addition, the multislice converter 300 includes timing-delay elements 330, 332 that provide the PMOS switch 102 and NMOS switch 104 of the parallel slice with respective phased-delayed-timing signals. Note that, because the hysteretic control does not use external timing source or oscillator, the phased-delayed-timing signals are generated simply by delaying by an appropriate amount the signals emanating from feedback controller circuit 114. Referring to FIG. 4, an exemplary multistage controller 400 having a plurality of timing-delay elements is provided. In the embodiment shown, a single controller 114 provides phased-delayed-timing signals 402, 404 and 406 to each of the PMOS switches 102 in a three stage multislice converter.

Also illustrated are phased-delayed-timing signals 408, 410 and 412, which are provided to each of the NMOS switches 102 in a three stage multislice converter. In an embodiment that uses a single gate drive, only phased-delayed-timing signals 402, 404 and 406 (or phased-delayed-timing signals 408, 410 and 412) will be used for both of the slice's PMOS and NMOS switches. Alternatively, in an embodiment utilizing resonant gate drive circuits, each of the signals 402, 404 and 406 (and possibly 408, 410 and 412) may be used to drive buffer driver/timer circuit of a resonant gate drive circuit.

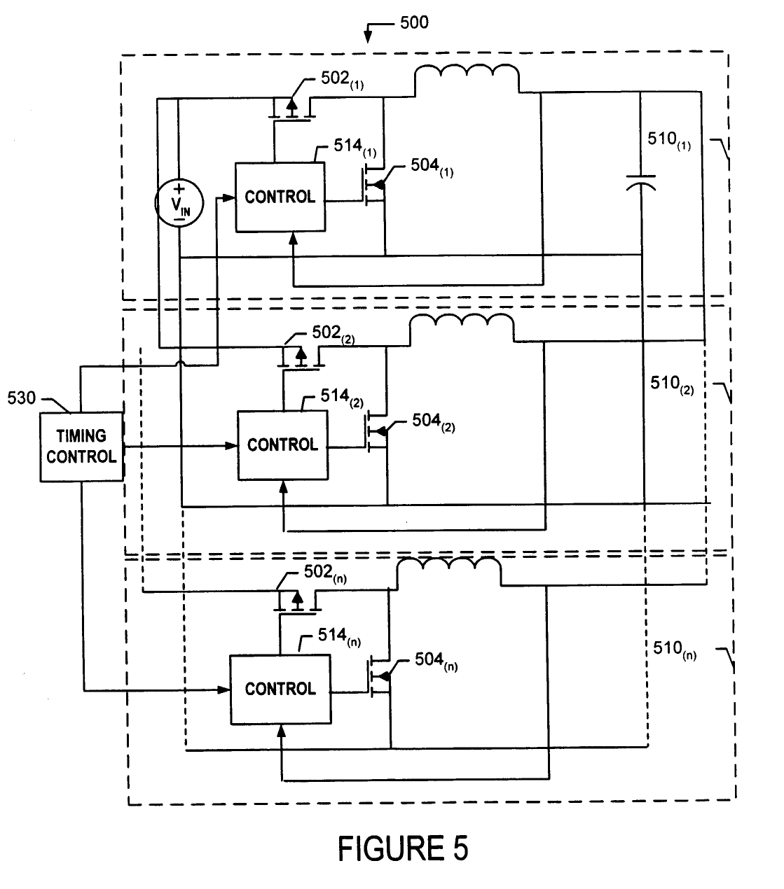

Referring now to FIG. 5, a schematic diagram of a dc-dc step-down voltage converter used as a preferred embodiment of a multislice converter 500 is provided. The multislice converter 500 illustrated in FIG. 5 is similar to the multislice converter 300 illustrated in FIG. 3 in most respects, except as described herein or otherwise noted. The multislice converter 500 includes a plurality of parallel converter slices 510₍₁₎, 510₍₂₎ . . . 510₍ₙ₎ with respective a feedback controller circuits 514₍₁₎, 514₍₂₎ . . . 514₍ₙ₎ that provide PWM and/or PFM control of the respective PMOS switches 502₍₁₎, 502₍₂₎ . . . 502₍ₙ₎ and NMOS switches 504₍₁₎, 504₍₂₎ . . . 504₍ₙ₎ with respective phased-delayed-timing signals as described above.

This configuration may also be viewed as a plurality of slices without an integral feedback controller circuit 514₍₁₎, 514₍₂₎ . . . 514₍ₙ₎, in combination with a separate controller that provides hysteretic switching control of the respective PMOS switches 502₍₁₎, 502₍₂₎ . . . 502₍ₙ₎ and NMOS switches 504₍₁₎, 504₍₂₎ . . . 504₍ₙ₎ of respective slices. And because the hysteretic control does not use external timing source or oscillator, the phased-delayed-timing signals are generated simply by delaying by an appropriate amount the signals emanating separate controller, such as multistage controller 400 referred to above.

A specific embodiment of a method and apparatus of dc voltage conversion has been described for the purpose of illustrating the manner in which the converter is made and used. It should be understood that the implementation of other variations and modifications is not limited by the specific embodiments described. Therefore it is contemplated to incorporate any and all modifications, variations, or equivalents that fall within the true spirit and scope of the basic underlying principles disclosed and claimed herein.

We claim:

1. A dc-dc voltage converter comprising:
a slice comprising:
a step-down converter comprising at least one monolithically formed regulator coupled to a capacitor and an inductor, wherein the at least one monolithically formed regulator comprises a switching controller, a switch, and a rectifier in a buck-type configuration, and wherein the switching controller operates at a load-dependent switching frequency in excess of approximately one megahertz; and
an oscillator-less-control circuit that monitors an output voltage of the step-down converter and when the converter falls below a given threshold voltage the oscillator-less-control circuit produces at least one set of dynamic switching pulses usable for triggering the switch and the rectifier.

2. The dc-dc voltage converter of claim 1, wherein the dynamic switching pulses comprise signals selected from the group of pulse-width-modulation signals, pulse-frequency-modulation signal, and hysteretic control signals.

3. The dc-dc voltage converter of claim 1, wherein the dynamic switching pulses comprise pulse-width-modulation signals.

4. The dc-dc voltage converter of claim 1, wherein the dynamic switching pulses comprise pulse-frequency-modulation signals.

5. The dc-dc voltage converter of claim 1, wherein the dynamic switching pulses comprise hysteretic control signals.

6. The dc-dc voltage converter of claim 1, wherein the dynamic switching pulses comprise pulse-width and pulse-frequency-modulation signals.

7. The dc-dc voltage converter of claim 1, wherein the oscillator-less-control circuit is integrated into the switching controller.

8. The dc-dc voltage converter of claim 1, wherein the oscillator-less-control circuit is integral into the switching controller.

9. The dc-dc converter of claim 1, wherein both the switch and the rectifier comprise MOSFET devices.

10. The dc-dc converter of claim 1, further comprising a feedback and startup circuit, the output of which provides at least one feedback signal useable for switching the switch and the rectifier.

11. The dc-dc converter of claim 10, wherein each of the at least one feedback signal is phase shifted from each other.

12. The dc-dc converter of claim 10, wherein the at least one feedback signal is generated using voltage-sense feedback.

13. The dc-dc converter of claim 10, wherein the at least one feedback signal is generated using current-sense feedback.

14. The dc-dc converter of claim 10, wherein the at least one feedback signal is generated using a combination of voltage-sense and current-sense feedback.

15. The dc-dc converter of claim 1, further comprising a plurality of slices connected in parallel providing an output across the capacitor, wherein the oscillator-less-control circuit monitors the output voltage of the multiple slices, and when the output voltage falls below a given threshold voltage, the oscillator-less-control circuit produces at least one set of dynamic switching pulses for triggering the respective switch and the rectifier of each of the multiple slices.

16. The- dc-dc converter of claim 15, further comprising a feedback and startup circuit, the output of which provides at least one feedback signal useable for switching the switch and the rectifier.

17. The dc-dc converter of claim 16, wherein the at least one feedback signal is generated using voltage-sense feedback.

18. The dc-dc converter of claim 16, wherein the at least one feedback signal is generated using current-sense feedback.

19. The dc-dc converter of claim 16, wherein the at least one feedback signal is generated using a combination of voltage-sense and current-sense feedback.

20. The dc-dc converter of claim 16, wherein each of the at least one feedback signal is phase shifted from each other.

21. The dc-dc converter of claim 16, wherein each of the at least one set of dynamic switching pulses is phase shifted from each other.

22. The dc-dc converter of claim 16, wherein each of the at least one set of dynamic switching pulses for each of the plurality of slices are phase shifted by the function 360°/n.

23. The dc-dc converter of claim 15, wherein each of the at least one set of dynamic switching pulses are generated by the use of hysteretic control.

24. The dc-dc converter of claim 15, wherein each of the at least one set of dynamic switching pulses are generated by the use of pulse-width-modulation control.

25. The dc-dc converter of claim 15, wherein each of the at least one set of dynamic switching pulses are generated by the use of pulse-frequency-modulation control.

26. A monolithic multislice step-down dc-dc converter comprising:
a plurality of slices, wherein each of the plurality of slices comprises:
a first switch having a first end and a second end, wherein the first end is connected to a high side of a power supply;
a second switch having a first end and a second end, wherein the first end is connected to the second end of first switch at a first common connection point, and wherein the second end is connected to a low side of the power supply; and
an inductor having a first end and a second end, wherein the first end is connected to the common connection point of the first and second switches; a capacitor having a first end and a second end, wherein the first end of the capacitor is connected at a second common connection point to the second end of each of the inductors of the plurality of slices, wherein the second end the capacitor is connected to the low side of the power supply, and wherein an voltage available across the capacitor defines a multislice step-down dc-dc converter output; and
a controller operating a load-dependent switching frequency in excess of approximately one megahertz comprising:
a feedback and startup circuit providing at least one feedback signal as a function of the multislice step-down dc-dc converter output and a reference voltage;
an oscillator-less-control circuit that monitors the at least one feedback signal and when the at least one feedback signal falls below a given threshold voltage, oscillator-less-control circuit produces at least one set of dynamic switching pulses usable for triggering the switch and the rectifier.

27. The monolithic multislice step-down dc-dc converter of claim 26, wherein each of the plurality of slices appear in parallel and share the second common connection point and a connection to the low side of the power supply, and wherein the oscillator-less-control circuit monitors the output voltage of the multiple slices, and when the output voltage falls below a given threshold voltage, the oscillator-less-control circuit produces at least one set of dynamic switching pulses for triggering the respective switch and the rectifier of each of the multiple slices.

28. The monolithic multislice step-down dc-dc converter of claim 26, wherein each of the plurality of slices, the capacitor, and the controller are fabricated within a substrate of an integrated circuit forming the monolithic dc-dc voltage step-down converter.

29. The monolithic multislice step-down dc-dc converter of claim 26, wherein each of the plurality of slices, the capacitor, and the controller are fabricated within a single substrate of an integrated circuit forming the monolithic dc-dc voltage step-down converter.

30. The monolithic multislice step-down dc-dc converter of claim 26, further including a resonant gate drive.

31. The monolithic multislice step-down dc-dc converter of claim 25, wherein the resonant gate drive is fabricated within the substrate of the integrated circuit forming the monolithic dc-dc voltage step-down converter.

32. The monolithic multislice step-down dc-dc converter of claim 26, further including a buffer driver/timer circuit.

33. The monolithic multislice step-down dc-dc converter of claim 26, wherein the buffer driver/timer circuit is fabricated within the substrate of the integrated circuit forming the monolithic dc-dc voltage step-down converter.

34. The monolithic multislice step-down dc-dc converter of claim 26, wherein the reference voltage is a dynamic reference voltage.

35. The monolithic multislice step-down dc-dc converter of claim 26, wherein the reference voltage is a static reference voltage.

36. The monolithic multislice step-down dc-dc converter of claim 26, wherein the at least one feedback signal comprises a signal selected from the group of signals consisting of those generated using voltage-sense feedback, generated using current-sense feedback, and generated using both voltage-sense and current-sense feedback signals.

37. The monolithic multislice step-down dc-dc converter of claim 26, wherein each of the at least one feedback signal is phase shifted from each other.

38. The monolithic multislice step-down dc-dc converter of claim 26, wherein each of the at least one set of dynamic switching pulses is phase shifted from each other.

39. The monolithic multislice step-down dc-dc converter of claim 26, wherein each of the at least one set of dynamic switching pulses for each of the plurality of slices are phase shifted by the function 360°/n.

40. The monolithic multislice step-down dc-dc converter of claim 26, wherein each of the at least one set of dynamic switching pulses is a set of pulses selected from the group consisting of signals generated by the use of hysteretic control, generated by the use of pulse-width-modulation control, and pulse-frequency-modulation control.
